(19) United States
(12) Patent Application Publication
(10) Pub. No.: US 2009/0000838 A1
(43) Pub. Date: Jan. 1, 2009

(54) Electric Motor for a Motor Vehicle and Associated Assembly Method

(75) Inventors: Thierry Pera, Belfort (FR); Jerome Maillard, Chamesol (FR)

Correspondence Address: YOUNG & THOMPSON, 209 Madison Street, Suite 500, ALEXANDRIA, VA, 22314, US

(73) Assignee: FAURECIA COOLING SYSTEMS, NANTERRE (FR)

(21) Appl. No.: 12/159,280

(22) PCT Filed: Dec. 22, 2006
(86) PCT No.: PCT/FR06/02859

§ 371 Date: Jun. 26, 2008

(30) Foreign Application Priority Data
Dec. 26, 2005 (FR) 0513327

(51) Int. Cl. B60K 1/00; H02K 15/02

(52) U.S. Cl. 180/65.4; 29/598

(57) ABSTRACT

This motor (10) comprises a main casing (12), a brush holder (18) positioned in the main casing (12) and an electrical power supply device (20) secured to the holder (18), comprising an electronic control board. The board has at least one connector (78, 44) for electrical connection to the brush holder (18). The motor (10) comprises an auxiliary casing (22) positioned on the outside of the main casing (12). The auxiliary casing (22) defines a liquid-tight interior volume housing the electronic board. The auxiliary casing (22) is mechanically connected to the brush holder (18) by the electrical connection connector (78, 44) through a passage opening (38) formed in the main casing (12).

The present invention relates to an electric motor for a motor vehicle, of the type comprising:
a main housing;
a brush carrier plate which is arranged in the main housing or which forms a wall of the main housing;
an electrical power supply device which is fixedly joined to the plate and which comprises an electronic control board which has at least one connector for electrical connection to the brush carrier plate.

FR-A-2 797 111 discloses an electric motor of the above-mentioned type, comprising a brush carrier plate. The motor further comprises a device for supplying electrical power to the brushes which comprises an electronic control board which is carried by the brush carrier plate.

The electronic board extends over a lateral extension of the brush carrier plate. It is offset relative to the axis of the motor for reasons of steric hindrance within the motor.

A motor of this type is not entirely satisfactory, in particular when it is used in a damp and/or corrosive environment.

Indeed, the electronic board is arranged in the main housing of the motor which contains the brush carrier plate. The electrical tracks of copper and the electronic components present on the board are therefore exposed to the environment of the motor and deteriorate when the motor is used in a damp and/or corrosive environment.

Furthermore, the structure of the main housing must be modified in order to accommodate a lateral compartment which is intended to receive the electronic board.

An object of the invention is to provide an electric motor in which the deterioration of the electronic control components is limited, even in a damp and/or hostile environment, without significantly modifying the structure of the main housing or impairing the mechanical strength of the motor.

To this end, the invention relates to a motor of the above-mentioned type, characterised in that the electrical power supply device comprises an auxiliary housing which is arranged at the outer side of the main housing, the auxiliary housing delimiting an inner space which is sealed with respect to liquids and which receives the electronic board, the auxiliary housing being mechanically connected to the brush carrier plate by means of the connector for electrical connection via a through-opening which is provided in the main housing.

The motor according to the invention may comprise one or more of the following features, taken in isolation or according to any technically possible combination:
the electrical power supply device comprises at least one lug for fixing to the main housing which protrudes from the auxiliary housing, the fixing lug being separate from the or each connection connector;
the main housing comprises a peripheral wall which surrounds the brush carrier plate and which defines a portion over the thickness thereof, the or each fixing lug being engaged on the portion;
it comprises a closing cover which is fixed to the peripheral wall and which covers the brush carrier plate, the or each fixing lug being axially retained in position on the portion by means of clamping between the cover and the portion;
at least one fixing lug is engaged in the through-opening;
the brush carrier plate comprises a base and, for the or each connector, a means for electrical connection which protrudes relative to the base, the electrical connection means of the plate being fitted to a complementary connection member of the electronic board;
the electrical connection member of the plate and the complementary connection member are welded together;
the auxiliary housing has a support wall which has a shape which substantially complements a peripheral surface of the main housing; and
the auxiliary housing extends laterally relative to the brush carrier plate, opposite the brush carrier plate.

The invention further relates to a method for assembling the motor as defined above, characterised in that it involves the following steps:
inserting the brush carrier plate into the main housing and inserting the electronic board into the auxiliary housing; and
fixing the auxiliary housing to the brush carrier plate by mechanically connecting the connection connector to the brush carrier plate via the through-opening.

The method according to the invention may comprise the following feature:
prior to the step for fixing the auxiliary housing, a step for engaging the or each lug for fixing the auxiliary housing to the main housing.

The invention will be better understood from a reading of the following description, given purely by way of example and with reference to the drawings, in which:

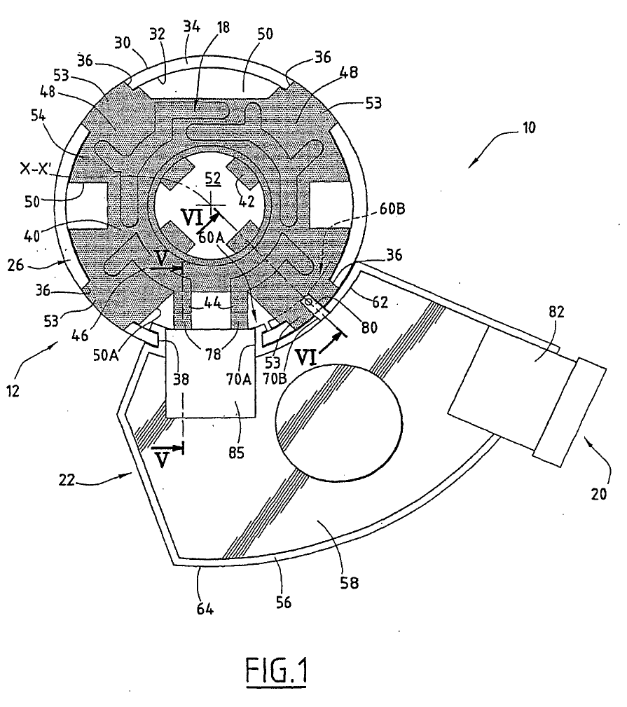

FIG. 1 is a plan view of a motor according to the invention, the cover of the motor being open;

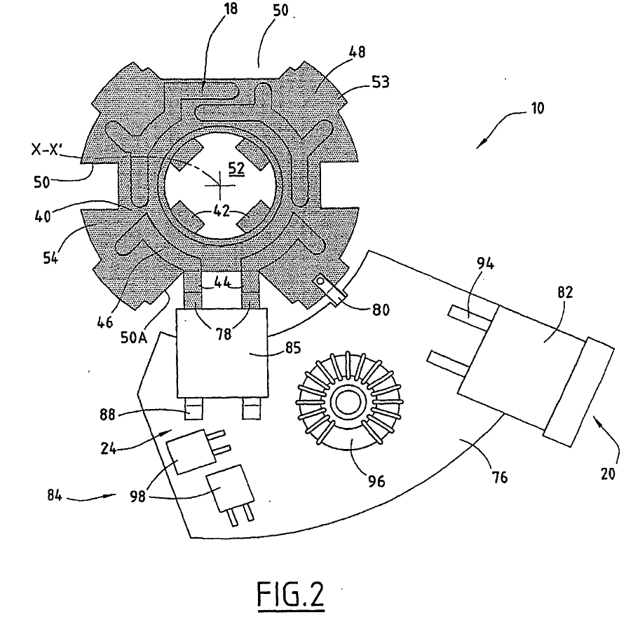

FIG. 2 is a plan view of the brush carrier plate and the electronic board of the motor of FIG. 1;

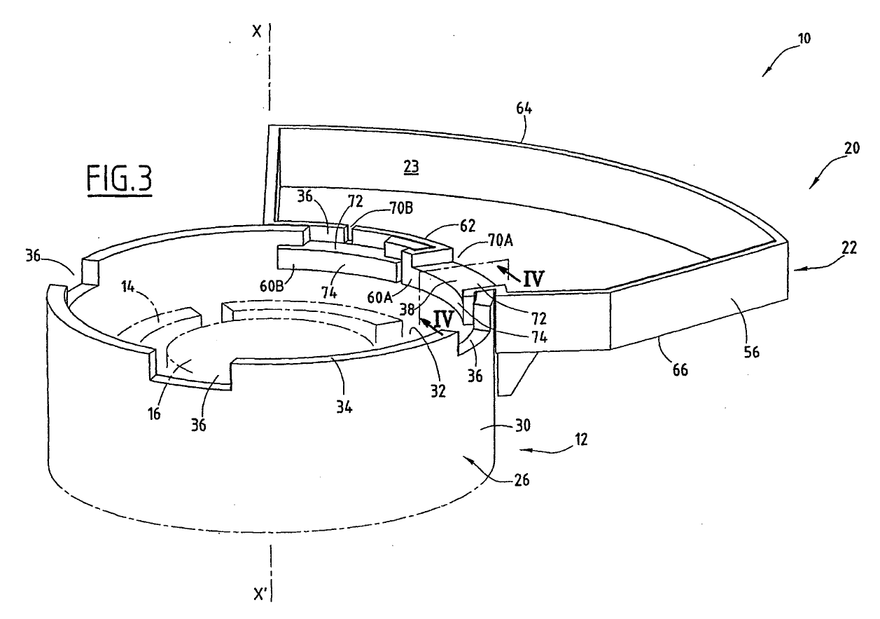

FIG. 3 is a three-quarter perspective front view of the motor of FIG. 1, the elements illustrated in FIG. 2 having been removed,

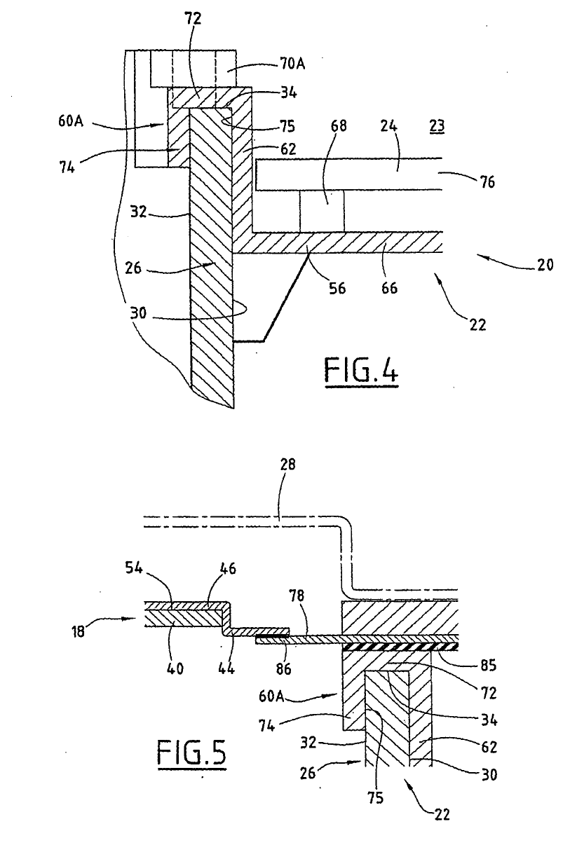

FIG. 4 is a partial section along the vertical plane IV-IV of FIG. 3;

FIG. 5 is a partial section along the vertical plane V-V of FIG. 1;

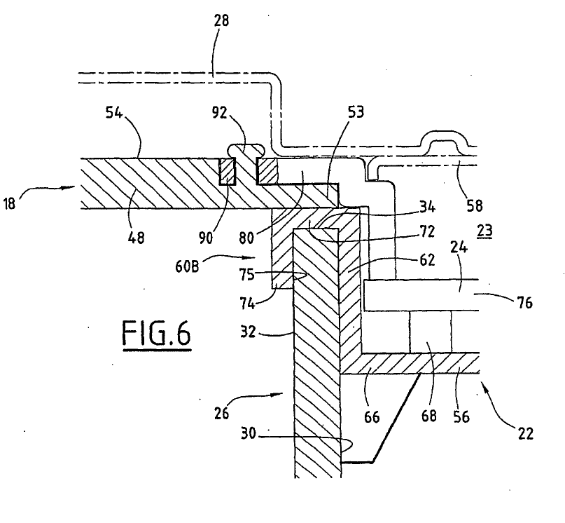

FIG. 6 is a partial section along the vertical plane VI-VI of FIG. 1.

The electric brush type motor 10 illustrated in FIGS. 1 to 6 is, for example, intended to rotatably drive a motor vehicle fan blade.

The motor 10 comprises a main housing 12 which can be seen in FIGS. 1 and 3. It comprises permanent magnets 14, a rotating armature 16 and a brush carrier plate 18 arranged in the main housing 12.

The motor 10 further comprises an electrical power supply device 20 which comprises an auxiliary housing 22 which is fixed to the main housing 12. The auxiliary housing 22 delimits a sealed inner space 23 which contains an electronic control board 24.

The main housing 12 of the motor comprises a substantially cylindrical casing 26 having an axis X-X′ and a cover 28 for closing the casing 26 illustrated with dotted lines in FIGS. 5 and 6.

The casing 26 has an outer peripheral surface 30 on which the auxiliary housing 22 is supported and an inner peripheral surface 32 which are connected together by means of a portion 34 which extends over the thickness of the casing 26 along an upper edge of this casing 26.

The casing 26 delimits, in the portion 34, four notches 36 for mounting the brush carrier plate 18, distributed around the axis X-X′, and a through-notch 38 for the connector provided opposite the auxiliary housing 22.

The motor cover 28 covers the opening defined by the upper edge of the casing 26.

As will be seen below, the cover 28 is pressed onto the upper edge of the casing 26 in order to retain the auxiliary housing 22 in position.

The permanent magnets 14 are fixed to the inner surface 32, below the brush carrier plate 18.

The armature 16 is mounted so as to rotate about the axis X-X′ opposite the magnets 14 and the brushes carried by the plate 18.

As illustrated in FIG. 2, the brush carrier plate 18 comprises a planar base 40, four brushes 42, two phase supply tags 44 and electrical routing tracks 46 which connect the phase supply tags 44 to the brushes 42.

The base 40 comprises four radial vanes 48 which are distributed around the axis X-X′ and which together define indentations 50. The base 40 delimits a central through-opening 52 of the armature 16.

Each vane 48 comprises on the periphery thereof a tooth 53 for mounting the plate 18 which is received in a mounting notch 36 having a corresponding shape.

Each brush 42 is fixed to a lower surface of the base 40 facing a vane 48.

The tracks 46 are arranged on an upper surface 54 of the base 40 between the indentation 50A which faces the through-notch 38 and each brush 42. They are produced based on copper.

The phase supply tags 44 protrude radially outwards in the indentation 50A which opens opposite the through-notch 38 for the connector. They are electrically connected to the tracks 46.

As illustrated in FIGS. 1 and 3, the auxiliary housing 22 comprises a receptacle 56, a cover 58 for sealed closure of the receptacle 56 and two lugs 60A, 60B for fixing the receptacle 56 which are engaged with the portion 34 of the casing 26.

The receptacle 56 comprises an inner support wall 62 which has a support surface having a shape which substantially complements the outer peripheral surface 30 of the casing 26. It further comprises an outer wall 64 and a base wall 66.

With reference to FIG. 4, the base wall 66 comprises support pins 68 which protrude upwards in order to support and fix the electronic board 24 in the auxiliary housing 22.

As illustrated in FIGS. 5 and 6, the inner wall 62 delimits horizontal through-openings 70A, 70B for the connector which open in the receptacle 56.

The through-openings 70A, 70B extend opposite the through-notch 38 and an adjacent mounting notch 36, respectively.

The fixing lugs 60A, 60B have a vertical cross-section which is substantially in the form of a hook. They each protrude towards the axis X-X′ relative to the inner wall 62 below the respective openings 70A and 70B, respectively.

As illustrated in FIG. 4, each lug 60A, 60B comprises an upper portion 72 which extends perpendicularly relative to the inner wall 62 in a notch 36, 38 and a support plate 74 which extends opposite the inner wall 62 on the inner peripheral surface 32 of the casing 26.

The inner wall 62, the upper portion 72 and the support plate 74 together delimit a groove 75 for receiving the portion 34 of the cylindrical casing 26 having a shape which complements this portion 34.

The inner space 23 is delimited by the inner wall 62, the outer wall 64, the base 66 and the cover 58 which is inserted in the receptacle 56 with a sealing joint being interposed (not illustrated).

The through-openings 70A, 70B open in the inner space 23.

As illustrated in FIG. 2, the electronic board 24 comprises a support plate 76, tags 78 for connecting to the phase supply tags 44 and an earth connection lug 80. The electronic board 24 further comprises a socket 82 for connecting an electrical power supply cable and a plurality of electronic control components 84.

The support plate 76 has a contour which substantially complements the contour of the inner space 23 in the receptacle 56. It is arranged so as to be supported on the pins 68.

The connection tags 78 are embedded in a sealing block 85 which is engaged in a sealed manner in the through-opening 70A. The block 85 has a shape which complements that of the opening 70A.

Each connection tag 78 has an inner end 86 which protrudes into the indentation 50A outside the space 23 and an outer end 88 which is welded to the support plate 76 inside the space 23.

As illustrated by FIG. 5, the inner end 86 is welded to an associated phase supply tag 44.

In this manner, as illustrated in FIG. 2, the electronic board 76 and the auxiliary housing 22 are connected mechanically and electrically to the brush carrier plate 18 by the connection tags 78 which are welded to corresponding phase tags 44. The tags 78 and 44 thus form a connector for electrical and mechanical connection of the plate 18 to the auxiliary housing 22.

As illustrated in FIG. 6, the earth connection lug 80 has an inner end 90 which protrudes towards the brush carrier plate through the opening 70B and the mounting notch 36 adjacent to the through-notch 38. The opening 70B has a vertical cross-section having a shape which complements the lug 80.

The inner end 90 is received in a corresponding housing which is provided in a vane 48 of the brush carrier plate 18. It is fixed in this housing by means of a rivet head 92.

The connection socket 82 partially protrudes through the outer wall 64 of the receptacle 56. It is intended to electrically connect an electrical power supply cable of the motor 10 to the electronic components 84 by means of routers 94 which are provided on the support plate 76.

The components 86 comprise, for example, an electrical transformer 96 and components 98 of the SMC type which are intended in particular to control the speed of the motor and/or to suppress interference.

The components 98 are connected, on the one hand, to the transformer 96 and, on the other hand, to the connection tags 78 in order to selectively supply the brushes 42 with electrical power.

The method for assembling the motor 10 according to the invention will now be described.

Initially, the magnets 14 are fixed to the inner peripheral surface 32 and the armature 16 is mounted so as to rotate in the casing 26.

Then, the receptacle 56 is mounted on the casing 26. To this end, the fixing lugs 60A, 60B are engaged on the casing 26 via the through-notch 38 and via an adjacent mounting notch 36. The portion 34 of the casing 26 penetrates into the grooves 75 until it moves into abutment against the upper wall 72.

In this configuration, the inner wall 62 of the receptacle 56 is arranged in abutment against the outer peripheral surface 30 of the casing 26 and the lugs 60A, 60B co-operate with the portion 34 in the notches 36,38. The receptacle 56 is thus fixed angularly about the axis X-X′.

Then, the electronic board 24 which carries the connection socket 82 and the electronic components 84 is arranged in the receptacle 56 supported on the pins 68.

During this step, the sealing unit 85 is engaged in the through-opening 70A, and in the opposing through-notch 38, supported on the upper portion 72 of the fixing lug 60A, as illustrated in FIG. 5.

The inner ends 86 of the connection tags 78 protrude into the casing 26. In the same manner, the earth connection lug 80 is engaged in the mounting notch 36 so as to protrude into the casing 26.

Then, the brush carrier plate 18 is inserted into the casing 26. To this end, the mounting teeth 53 are placed in the corresponding notches 36 in order to lock the brush carrier plate 18 in position about the axis X-X′. The tooth 53 opposite the earth connection lug 80 is caused to slide below this lug 80.

Then, the connection tags 78 are welded to the phase supply tags 44 so that the brush carrier plate 18 and the receptacle 22 are connected electrically and mechanically together by means of the tags 78, 44 via the through-notch 38.

The connection lug 80 is then pressed against the brush carrier plate 18, causing the rivet head 92 to penetrate into an opening which is provided in this lug 80.

Then, a sealing joint is interposed between the receptacle 56 and the cover 58 in order to close the inner space 23 in a sealed manner.

In this manner, any contamination of the inner space 23 by a damp or corrosive external medium is prevented. The support plate 76 and the components 84 can therefore be produced using materials of lower cost, since these elements are protected from the external environment in the auxiliary housing 22. The cost of the motor is therefore reduced.

Then, in order to retain the auxiliary housing 22 in position, the motor cover 26 is crimped over the upper edge of the casing 26. In this manner, as illustrated in FIGS. 5 and 6, the mounting teeth 53 of the brush carrier plate 18, the upper walls 72 of the fixing lugs 60A, 60B and the tags 44, 78 are retained clamped between the motor cover 28 and the portion 34 of the casing 26. The auxiliary housing 22 is therefore fixed in a robust manner to the main housing 12 using simple and cost-effective means.

An electrical power supply cable can be connected in the socket 82 in order to allow the brushes 42 to be supplied with electrical power via the electronic board 24, the connection tags 78, the phase supply tags 44, and the routing tracks 46 in order to rotatably drive the armature 16 about the axis X-X′.

1.-11. (canceled)

12. Electric motor for a motor vehicle, of the type comprising:
a main housing;
a brush carrier plate which is arranged in the main housing or which forms a wall of the main housing;
an electrical power supply device which is fixedly joined to the plate and which comprises an electronic control board which has at least one connector for electrical connection to the brush carrier plate;
wherein the electrical power supply device comprises an auxiliary housing which is arranged at the outer side of the main housing, the auxiliary housing delimiting an inner space which is sealed with respect to liquids and which receives the electronic board, the auxiliary housing being mechanically connected to the brush carrier plate by means of the connector for electrical connection via a through-opening which is provided in the main housing.

13. Motor according to claim 12, wherein the electrical power supply device comprises at least one lug for fixing to the main housing which protrudes from the auxiliary housing, the fixing lug being separate from the or each connection connector.

14. Motor according to claim 13, wherein the main housing comprises a peripheral wall which surrounds the brush carrier plate and which defines a portion over the thickness thereof, the or each fixing lug being engaged on the portion.

15. Motor according to claim 14, further comprising a closing cover which is fixed to the peripheral wall and which covers the brush carrier plate, the or each fixing lug being axially retained in position on the portion by means of clamping between the cover and the portion.

16. Motor according to claim 13, wherein at least one fixing lug is engaged in the through-opening.

17. Motor according to claim 14, wherein at least one fixing lug is engaged in the through-opening.

18. Motor according to claim 12, wherein the brush carrier plate comprises a base and, for the or each connector, a means for electrical connection which protrudes relative to the base, the electrical connection means of the plate being fitted to a complementary connection member of the electronic board.

19. Motor according to claim 13, wherein the brush carrier plate comprises a base and, for the or each connector, a means for electrical connection which protrudes relative to the base, the electrical connection means of the plate being fitted to a complementary connection member of the electronic board.

20. Motor according to claim 18, wherein the electrical connection member of the plate and the complementary connection member are welded together.

21. Motor according to claim 12, wherein the auxiliary housing has a support wall which has a shape which substantially complements a peripheral surface of the main housing.

22. Motor according to claim 13, wherein the auxiliary housing has a support wall which has a shape which substantially complements a peripheral surface of the main housing.

23. Motor according to claim 12, wherein the auxiliary housing extends laterally relative to the brush carrier plate, opposite the brush carrier plate.

24. Motor according to claim 13, wherein the auxiliary housing extends laterally relative to the brush carrier plate, opposite the brush carrier plate.

25. Method for assembling a motor according to claim 12, which comprises the following steps:
inserting the brush carrier plate into the main housing;
inserting the electronic board into the auxiliary housing; and
fixing the auxiliary housing to the brush carrier plate by mechanically connecting the connection connector to the brush carrier plate via the through-opening.

26. Method for assembling a motor according to claim 13, which comprises the following steps:
inserting the brush carrier plate into the main housing;
inserting the electronic board into the auxiliary housing; and
fixing the auxiliary housing to the brush carrier plate by mechanically connecting the connection connector to the brush carrier plate via the through-opening.

27. Method according to claim 26, further comprising, wherein that it comprises, prior to the step for fixing the auxiliary housing, a step for engaging the or each lug for fixing the auxiliary housing to the main housing.
